(19) United States
(12) Patent Application Publication
(10) Pub. No.: US 2008/0209056 A1
(43) Pub. Date: Aug. 28, 2008

(54) SYSTEM AND METHOD OF SHARING MULTIMEDIA CONTENT

(75) Inventor: Myoung-soon CHOI, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/834,943

(22) Filed: Aug. 7, 2007

(30) Foreign Application Priority Data
Feb. 26, 2007 (KR) 10-2007-0019152

(51) Int. Cl. G06F 15/16

(52) U.S. Cl. 709/229

(57) ABSTRACT

Provided is a system and method of sharing content with a multimedia content server. The multimedia content sharing system includes: a content server providing multimedia content; a slave storing authentication information to be connected to the content server through a network; and a host connected to the content server by using the authentication information of the slave to transmit and receive the multimedia content. According to the system and the method, the host can transmit and receive data to and from a web content server through a network without the operation of an external device. Additionally, the system and the method allow a user to select a storage mode of a slave, and a host to recognize the selected storage mode of a slave automatically, thereby improving convenience for a user. That is, the user does not need to select the communication protocol of a slave for connection between the host and the content server.

### CROSS-REFERENCE TO RELATED PATENT APPLICATION

This application claims the benefit of Korean Patent Application No. 10-2007-0019152, filed on Feb. 26, 2007, in the Korean Intellectual Property Office, the disclosure of which is incorporated herein in its entirety by reference.

### BACKGROUND OF THE INVENTION

1. Field of the Invention

The present invention relates to content sharing with a multimedia content server, and more particularly, to a system and method of sharing content with a multimedia content server when a host uses the authentication information of a slave device.

2. Description of the Related Art

As illustrated in FIG. 1, a portable device, in this case a digital camera 11, includes a network interface 111, so that it can transmit and receive data to and from a web content server 13 through a network without the support of an external device such as a PC, etc. Accordingly, the digital camera 11 can directly upload photographs and recorded music to the web content server 13 and can download such multimedia content from the web content server 13.

In addition, as illustrated in FIG. 2, an external device 12 such as a PC is linked with the web content server 13 through a network to upload or download multimedia content.

However, both the digital camera 11 and any PCs must download authentication information beforehand by performing authentication procedures in order to share multimedia content with the web content server 13. Conventionally, a user must repeat authentication procedures for both the digital camera 11 and each PC in order to connect the digital camera 11 or PCs with the content server 13. Accordingly, time and expense for the authentication procedures and device management efforts increase in proportion to the number of devices.

In order to avoid repetition of authentication procedures, as illustrated in FIG. 3, the user performs the authentication procedures only for the digital camera 11, and then downloads content from the web content server 13 to the digital camera 11 in operations 311 through 314. Then, the PC receives content from the digital camera 11 and uses the content in operations 321 and 322. However, this method is time consuming and indirect, thereby causing inconvenience for the user.

### SUMMARY OF THE INVENTION

The present invention provides a method and a system for sharing multimedia content by obtaining authentication information by a single authentication procedure and sharing the authentication information with various devices.

According to an aspect of the present invention, there is provided a multimedia content sharing system that includes: a content server providing multimedia content; a slave storing authentication information to be connected to the content server through a network; and a host connected to the content server by using the authentication information of the slave to transmit and receive the multimedia content.

According to another aspect of the present invention, there is provided a method of sharing multimedia content between a host and a slave connected to a content server providing multimedia content, the method including: receiving authentication information from the slave by using the host; utilizing the received authentication information by using the host and connecting the host to the content server; and transmitting and receiving the content to and from the content server by using the host.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional content sharing system used between a digital camera and a content server;

FIG. 2 is a block diagram of a conventional content sharing system used between PCs and a content server;

FIG. 3 is a view of data flow using a conventional content sharing method between a digital camera, a PC, and a content server;

FIG. 4 is a block diagram of a content sharing system according to an embodiment of the present invention;

FIG. 5 is a view of data flow using a content sharing method according to an embodiment of the present invention; and

FIG. 6 is a flowchart of a content sharing method according to an embodiment of the present invention.

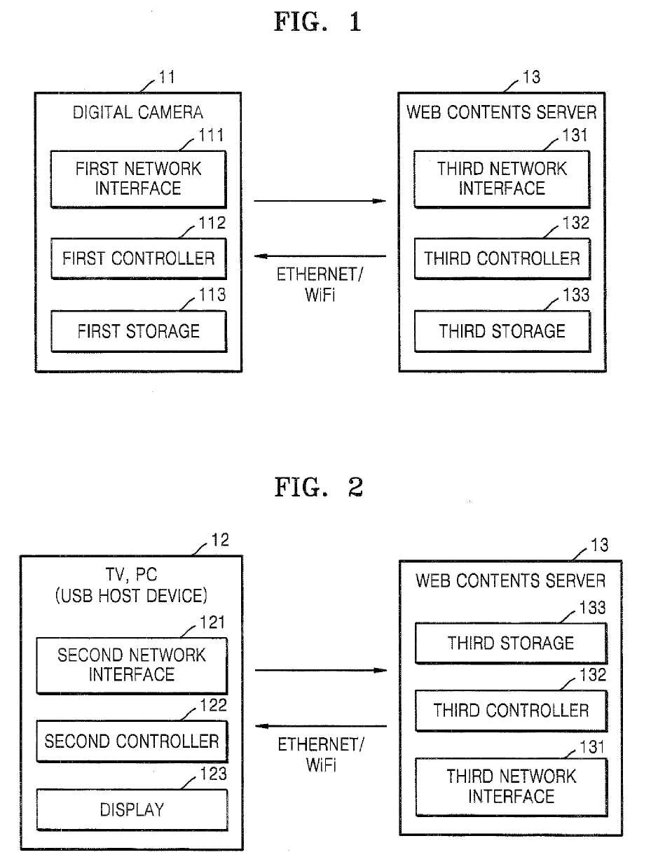

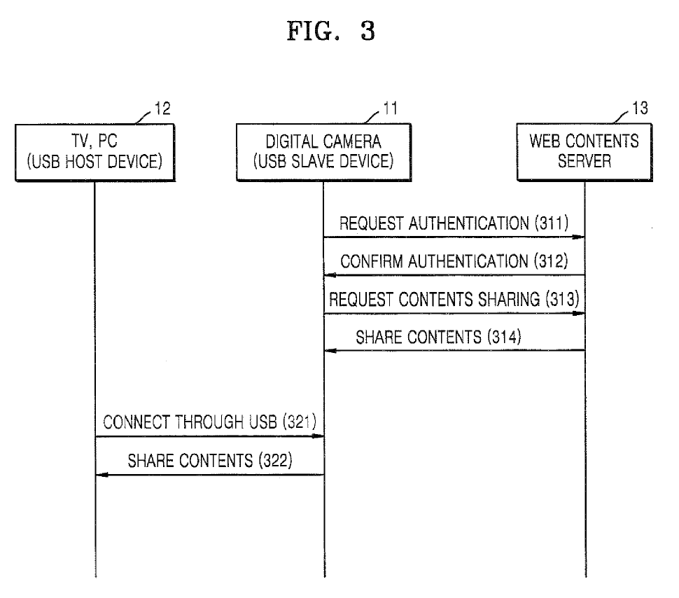

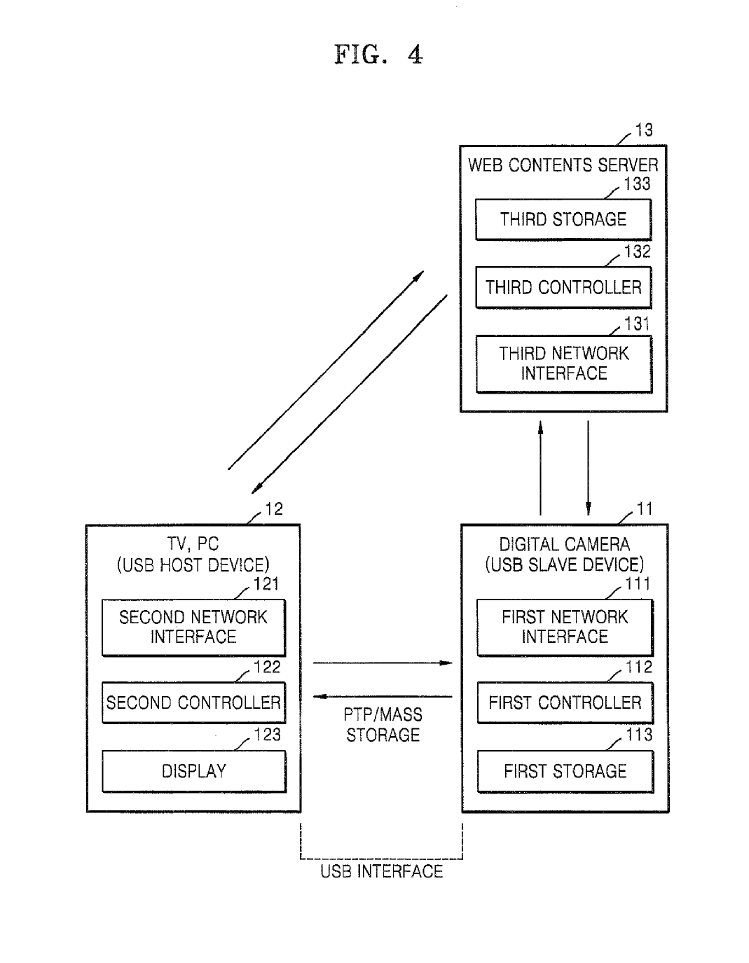

### DETAILED DESCRIPTION OF THE INVENTION

Hereinafter, embodiments of the present invention will be described with reference to the drawings.

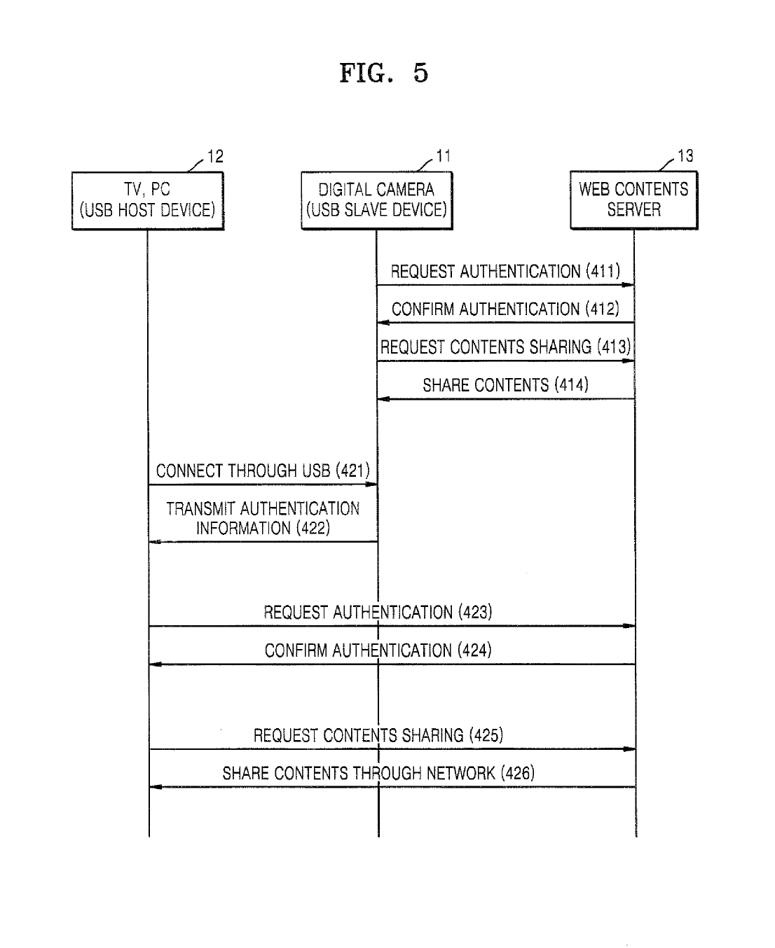

FIG. 4 is a block diagram of a content sharing system according to an embodiment of the present invention.

The multimedia content sharing system of the present invention includes a web content server 13, a host 12, and a slave 11.

The web content server 13 includes a third network interface 131, a third controller 132, and a third storage unit 133. The web content server 13 is a content server computer existing in the Internet or in a LAN and the third storage unit 133 of the web content server 13 stores a variety of multimedia content (e.g., moving pictures, still pictures, music, etc.).

The host 12 includes a second network interface 121, a second controller 122, and a display 123. In the embodiment illustrated in FIG. 4, a digital TV is adopted as the host 12, but a network display, a PC, etc. can also be adopted as the host 12 that is connected to the slave 11.

The host 12 is electrically connected to the web content server 13 through the Internet or a LAN. Accordingly, the host 12 and the web content server 13 include network interfaces 121 and 131 supporting such telecommunication protocols as Ethernet, WiFi, CDMA, etc.

The slave 11 includes a first network interface 111, a first controller 112, and a first storage unit 113. In the embodiment illustrated in FIG. 4, a digital camera is adopted as the slave 11, but a portable device such as a portable multimedia player (PMP) can also be adopted as the slave 11.

Since the slave 11 is electrically connected to the content server 13 through the Internet or a LAN, a network interface 111 is able to support such telecommunication protocols as Ethernet, WiFi, CDMA, etc. While the slave 11 operates with the web content server 13 in a server-client relationship, the slave 11 operates with the host 12 in a host-slave relationship and thus an interface for data communication between the devices is required.

A Universal Serial Bus (USB) interface or an IEEE 1394 interface is selected as a local interface to connect the host 12 and the slave 11.

According to FIG. 4, a digital camera 11 provides local storage mode and network storage mode as storage modes.

When the storage mode of the digital camera is set to local storage mode by a user, the digital camera should support a mass storage method, a picture transfer protocol (PTP) method, or PictBridge, as a data transmission method between digital camera 11 and a digital TV 12.

The PTP is a communication protocol that is designed to transmit pictures taken by the digital camera into a computer or another peripheral device without an additional driver.

PictBridge is a standard protocol that is used to directly transmit image data taken by the digital camera into a printer.

Additionally, the digital camera 11 stores authentication information in the first storage unit 113. The authentication information is used to connect to the content server 13. Examples of authentication information are an ID, a password, an encrypted authentication key, etc.

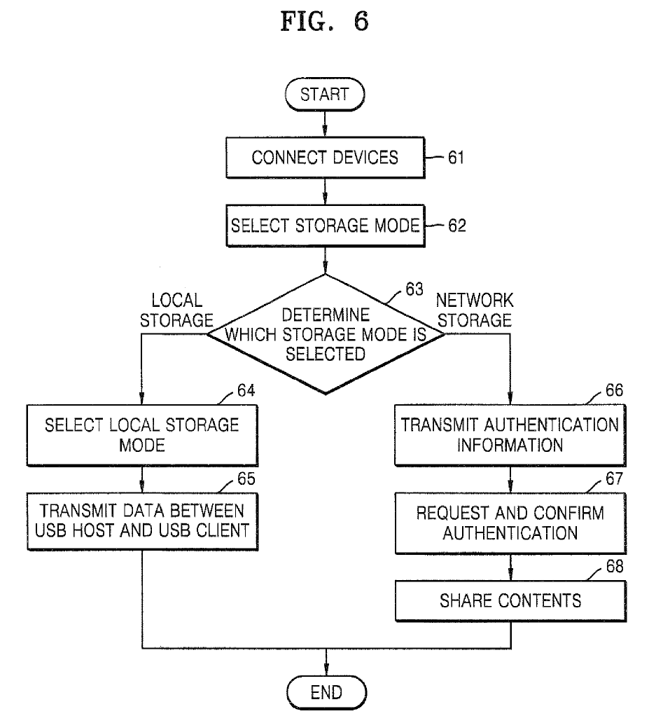

FIG. 6 is a flowchart of a content sharing method according to an embodiment of the present invention.

Devices constituting a content sharing system of the present invention are connected in operation 61.

The host 12 and the slave 11 are electrically connected through a local interface, e.g., USB. Additionally, the content server 13 and the host 12, and the content server 13 and the slave 11 are electrically connected to each other in server-client relationship, respectively.

In operation 62, a user selects a storage mode of the slave 11. The slave 11 provides a local storage mode and a network storage mode as storage modes.

In operation 63, the host 12 determines which storage mode is selected by the slave 11.

If the user selects the local storage as the storage mode of the slave 11, the user selects again a data transmission method between the host 12 and the slave 11 in operation 64.

The data transmission methods that can be selected by the user include a mass storage method, a PTP method, and PictBridge.

In operation 65, multimedia content and other data are transmitted from the slave 11 to the host 12 by using the data transmission method selected in operation 64.

According to the determination result of the host 12 in operation 63, if the user selects network storage as the storage mode of the slave 11, the host 12 receives authentication information from the slave 11 to connect to the content server 13 in operation 66. The slave 11 downloads authentication information to connect to the content server 13, and stores the authentication information in storage before operation 66. After operation 66, the connection between slave and host is no longer needed.

In operation 67, the host 12 transmits the authentication information received from the slave 11 into the content server 13 to request authentication. In response to the request, the content server 13 confirms the authentication information and then allows the host 12 to connect.

After the host 12 goes through the authentication procedures, it downloads content from the content server 13 or uploads content to the content server 13 in operation 68.

FIG. 5 is a view of data flow using a content sharing method according to an embodiment of the present invention.

Unlike a conventional technique, according to the content sharing method of the present invention, the host 12 utilizes the authentication information of the slave 11 without repeating the authentication procedures and easily shares content with the content server 13 in operations 421 through 426.

According to a system and a method for sharing content with a multimedia content server, the host can easily share content with the content server without going through an additional authentication procedure.

Additionally, according to the present invention, a user is able to select the storage mode of the slave, which is automatically recognized by the host, thereby improving convenience for the user. That is, the user does not need to set the communication protocol of the slave for connection between the host and the content server.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A multimedia content sharing system comprising:
a content server providing multimedia content;
a slave storing authentication information to be connected to the content server through a network; and
a host connected to the content server by using the authentication information of the slave so as to transmit and receive multimedia content.

2. The multimedia content sharing system of claim 1, wherein the slave operates as one of local storage and network storage with respect to the host.

3. The multimedia content sharing system of claim 2, wherein, when the slave operates as network storage with respect to the host, the host receives the authentication information from the slave.

4. The multimedia content sharing system of claim 2, wherein, when the slave operates as local storage with respect to the host, the host receives content from the slave.

5. The multimedia content sharing system of claim 4, wherein the host receives the content from the slave by using one data transmission protocol of mass storage, a PTP (picture transfer protocol), and PictBridge.

6. The multimedia content sharing system of claim 1, wherein the slave and the host are electrically connected to each other by using a local interface.

7. The multimedia content sharing system of claim 6, wherein the local interface is one of a USB (Universal Serial Bus) interface and an IEEE 1394 interface.

8. The multimedia content sharing system of claim 1, wherein the host and the slave are electrically connected to the content server through a network interface, respectively.

9. The multimedia content sharing system of claim 1, wherein the slave downloads and stores the authentication information in advance so as to connect to the content server.

10. A method of sharing multimedia content between a host and a content server or a slave and a content server providing multimedia content, the method comprising:
the host receiving authentication information from the slave;
the host utilizing the received authentication information and connecting to the content server; and
the host transmitting and receiving the content to and from the content server.

11. The method of claim 10, wherein the authentication information is downloaded and stored in the slave in advance so as to connect to the content server.

12. The method of claim 10, further comprising selecting the storage mode of the slave before the receiving of the authentication information.

13. The method of claim 12, wherein, when network storage is selected as the storage mode of the slave, the host receives the authentication information from the slave.

14. A host for sharing multimedia content between a host and a content server or a slave and a content server providing multimedia content; the host receives the authentication information from the slave so as to connect to the content server, and then transmits and receives the content to and from the content server by using the authentication information.

15. The method of claim 14, wherein the host, after receiving the authentication information, no longer requires a connection to the slave.
